(19) United States
(12) Patent Application Publication
(10) Pub. No.: US 2003/0065902 A1
(43) Pub. Date: Apr. 3, 2003

(54) System and method for storage management

(76) Inventors: Akio Shiga, Hadano (JP); Koji Asakura, Odawara (JP)

Correspondence Address: Mattingly, Stanger & Malur, P.C, Suite 370, 1800 Diagonal Road, Alexandria, VA, 22314, US

(21) Appl. No.: 10/077,879

(22) Filed: Feb. 20, 2002

(30) Foreign Application Priority Data
Oct. 2, 2001 (JP) 2001-306495

(51) Int. Cl. G06F 12/00

(52) U.S. Cl. 711/170

(57) ABSTRACT

A storage management system including storage management server having storage control management means for issuing alternation of configuration information to storage system and reflecting the result of the alternation of configuration information to data base, wherein the storage management system updates corresponding configuration information in configuration information file and updated history information corresponding to the configuration information, configuration information and updated history information is updated by transferring only alternated configuration information and updated history information from the storage system into storage management server, upon request of alternation of the configuration information from the storage management server to the storage system.

### BACKGROUND OF THE INVENTION

The present invention relates to a management control of a storage system. More particularly, the present invention is concerned with a technique for effectuating information update processing with enhanced efficiency at high speed by suppressing the amount or quantity of information required for the storage system to a minimum.

In the storage system, operations such as data input/output operation and others are performed in conformance with configuration information which is stored internally of the storage system. At this juncture, it is contemplated with the phrase “configuration information” to mean the information which is required for the operation of the storage system such as, for example, size, number and types of storages incorporated in the storage system, information concerning the paths set up for the storages (also referred to as the path setting information) and the like. The configuration information of the storage system shows a yearly increase in accompanying the increase in the number of storages incorporated in the storage system and the capacity thereof. Besides, the configuration information tends to increase more and more in dependence on increase of the system functions and sophistication thereof.

The storage system is incapable of modifying or altering the configuration information by itself. Under the circumstances, a storage managing server and a storage managing client are provided for altering the configuration information. In general, the storage managing server is ordinarily disposed at a location near to the storage system and connected to a dedicated local area network (LAN). The storage managing server is provided primarily for the purpose of management and control of the storage system. Parenthetically, storage of the data in the storage system is carried out by a data transaction server provided to this end separately from the storage managing server.

By contrast, the storage managing client is generally installed at a remote site, being connected to a global LAN through a gateway and a hub so that the storage managing client can control the storage system from the remote site.

Heretofore, when the configuration of the storage system is to be altered by the storage managing server or the storage managing client, it has been impossible to identify discriminatively whether the configuration information of the storage system used currently by the storage managing server or the storage managing client is in the up-to-date state or not because the storage managing server or the storage managing client is not in the position to know if or when the configuration information of the storage system was updated.

Under the circumstances, for realizing the up-to-date state, such a procedure is resorted to that all the configuration information is transferred from the storage system to the storage managing server or the storage managing client where the database is arranged or regenerated. In that case, load is imposed on the network by an interface which is employed to this end and which differs from the interface through which the data read/write operation of the storage system is performed (out-of-band scheme). Furthermore, in the storage managing server as well as the storage managing client, a lot of time is taken for generating or preparing the database for the whole configuration information.

In this conjunction, there is disclosed, for example, in Japanese Patent Application Laid-Open Publication No. 339098/2000 a method of managing the interconnection statuses (connections of PCs, servers, etc.) of a network in the storage area network environment (SAN environment) by displaying virtually the interconnections with a single server. This method is known as the so-called in-band scheme according to which the same interface as the one through which the server reads/writes the data in/from the storage is made use of for manipulating and managing the configuration information of the storage system as well. This known managing scheme however suffers a problem that in case some fault should occur in the server managing unitarily the storage area network, rendering it impossible to use that server, there will arise such unwanted serious situation that the whole network can no more be managed.

### SUMMARY OF THE INVENTION

As is apparent from the above, with the hitherto known techniques, a lot of time is taken for transferring all the configuration information of the storage upon every alteration of the system configuration of the storage system. Furthermore, load imposed on the network increases, giving rise to a problem on the system itself. Additionally, because the database has to be rearranged or regenerated in the storage managing server and the storage managing client, lots of time is taken for the processings involved, presenting another problem.

In the light of the state of the art described above, it is an object of the present invention to provide a method and a system for storage management which are capable of suppressing to a minimum the amount of information to be transferred upon alteration of the configuration information of a storage system as well as the number of processing steps involved in rearranging or regenerating a database in a storage managing server and a storage managing client.

According to the teachings of present invention, the configuration information as altered is transferred to the storage managing server from the storage system. Thus, the storage managing server can always be maintained in the up-to-date state. As a result of this, there aries no necessity of updating the database upon alteration of the configuration information, to a great advantage. Besides, when such a situation should take place in which a server can not be operated for some reason, management of the storage system is then performed by using another server installed preparatorily. Owing to this arrangement, management of the storage system can be performed with high safety and reliability.

In view of the above and other objects which will become apparent as the description proceeds, there are provided according to the present invention the method and the system which will be described below.

The present invention is directed to a storage system comprising a storage in which data are stored, a configuration file for storing configuration information required for operating the storage system, inclusive of path setting information for the storage, and additionally storing update history information indicative of information having been updated as management information for each of the configuration information, and storage management control means for altering the configuration information and the update history information in response to an external request.

In conjunction with the storage system mentioned above, there is provided according to one aspect of the present invention a method of managing the storage with the aid of a storage managing server which comprises a database storing therein configuration information and update history information for each of the configuration information for managing the storage system, and storage managing means for issuing a request for altering the configuration information to the storage system while reflecting result of the alteration of the configuration information in the database, wherein the storage management method comprises a step of responding to issuance of a request for alteration of the configuration information by the storage managing server to the storage system for thereby updating relevant one of the configuration information stored in the configuration information file and the update history information paired with the relevant configuration information, and a step of transferring only the altered configuration information and update history information to the storage managing server from the storage system to thereby allow the corresponding configuration information and update history information both stored in the database to be updated.

Further, the present invention is directed to a storage system comprising a plurality of storages in which data are stored, a configuration information file for storing a plurality of storage configuration information inclusive of path setting information for the plurality of storages and update history information prepared in correspondence to the plurality of storage configuration information, respectively, for indicating that corresponding configuration information has been updated, and storage management control means responsive to a request for alteration of storage configuration as issued from external control means to thereby alter the storage configuration while altering the storage configuration information and the update history information in correspondence to alteration of the storage configuration, the external control means including a database storing therein the configuration information and the update history information.

In conjunction with the storage system described above, there is provided according to another aspect of the present invention a method of managing the storages which comprises a step in which the storage management control means responds to a request issued by the external control means for thereby altering configuration of the storage while updating the configuration information and update history information stored in the configuration information file in correspondence to the alteration of the storage configuration, a step in which the configuration information and the update history information which have been updated in the first step are transferred to the external control means, and a step in which the external control means updates the database on the basis of the information transferred to the external control means.

Furthermore, the present invention is directed to a storage system comprising a storage in which data are stored, a configuration file for storing therein configuration information required for operating the storage system, inclusive of path setting information for the storage, and update history information indicative of information having been updated for each of the configuration information, and storage management control means for altering the configuration information and the update history information in response to an external request, wherein the storage system is equipped with a storage managing server which comprises a database storing therein configuration information and update history information for each of the configuration information for managing the storage system, and storage managing means for issuing a request for altering the configuration information to the storage system while reflecting result of the alteration of the configuration information in the database, and further equipped with at least one storage managing client connected to the storage managing server by way of a network and designed to request alteration of the configuration information of the storage system.

In conjunction with the system described above, there is provided according to yet another aspect of the present invention a method of managing the storage which comprises a step of responding to issuance of a request for alteration of the configuration information of the storage system from the storage managing client for thereby updating relevant configuration information stored in the configuration information file and the update history information paired with the relevant configuration information through the medium of the storage managing means of the storage managing server, and a step of transferring the altered configuration information and update history information to the storage managing client from the storage system through the medium of the database and the storage managing means of the storage managing server to thereby update the corresponding configuration information and update history information stored in the storage managing client.

In a mode for carrying out the present invention, the method described just above should preferably include a step of responding to alteration of the configuration information of the storage system to thereby register in the storage managing server the configuration information which is to be informed to the storage managing clients on a client-by-client basis, and a step of responding to alteration of the registered configuration information to thereby transfer the altered configuration information and the update history information paired with the altered configuration information to the storage managing client.

Other objects, features and advantages of the invention will become apparent from the following description of the embodiments of the invention taken in conjunction with the accompanying drawings.

### BRIEF DESCRIPTION OF THE DRAWINGS

In the course of the description which follows, reference is made to the drawings, in which:

FIG. 1 is a block diagram showing a network configuration including a storage system and a storage managing server based on a storage managing scheme according to an embodiment of the present invention;

FIG. 2 is a block diagram showing examples of information used in the storage system;

FIG. 3 is a block diagram showing examples of information used in the storage managing server;

FIG. 4 is a flow chart for illustrating, by way of example, operation of the storage system based on the storage managing scheme according to an embodiment of the present invention;

FIG. 5 is a flow chart for illustrating, by way of example, operation of the storage managing server based on the storage managing scheme according to an embodiment of the present invention;

FIG. 6 is a diagram for illustrating flows of processing upon execution of a request for alteration of configuration information of the storage system as issued by a storage managing server according to an embodiment of the present invention;

FIG. 7 is a view for illustrating a part of path information contained in the configuration information;

FIG. 8 is a view showing, by way of example, a request for configuration alteration of the storage system;

FIG. 9 is a view showing, a part of path information after configuration alteration; and

FIG. 10 is an image view showing an example of the configuration information displayed on a storage managing client.

### DESCRIPTION OF THE EMBODIMENTS

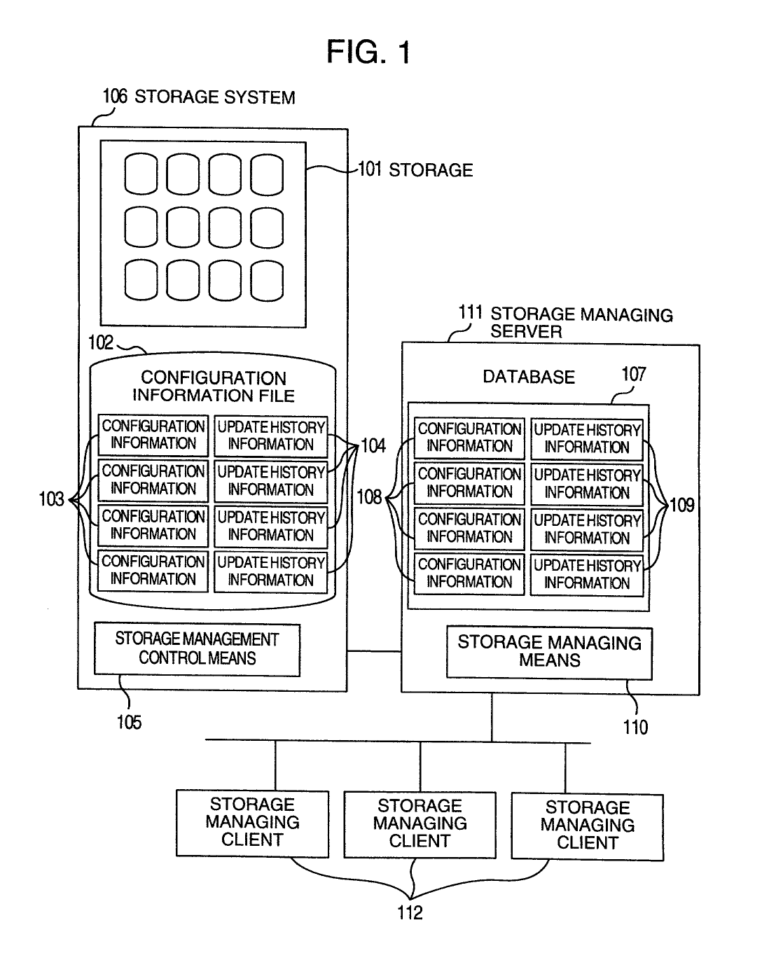

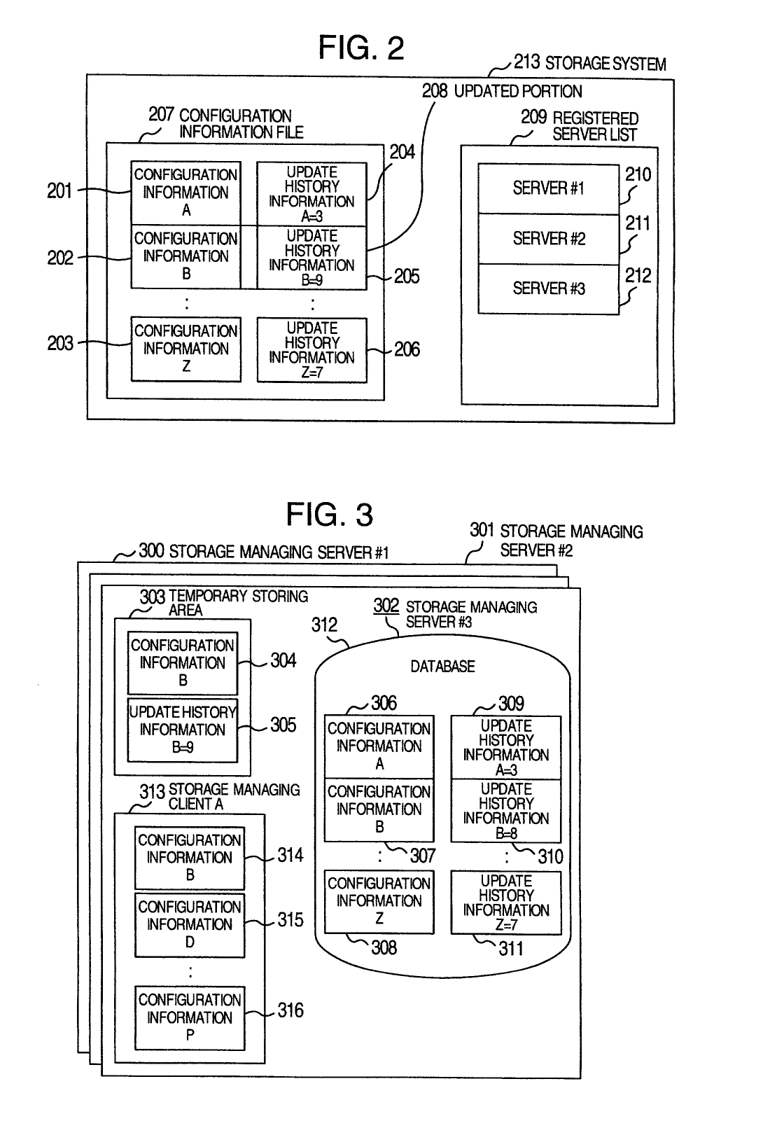

In the following, the storage managing scheme according to an exemplary embodiment of the present invention will be described by reference to FIGS. 1 to 10. FIG. 1 is a block diagram showing a structure or configuration of a network which includes a storage system and a storage managing server implemented on the basis of the storage managing scheme according to an embodiment of the invention, FIG. 2 is a block diagram showing examples of the information made use of in the storage system, and FIG. 3 is a block diagram showing examples of the information made use of in the storage managing server.

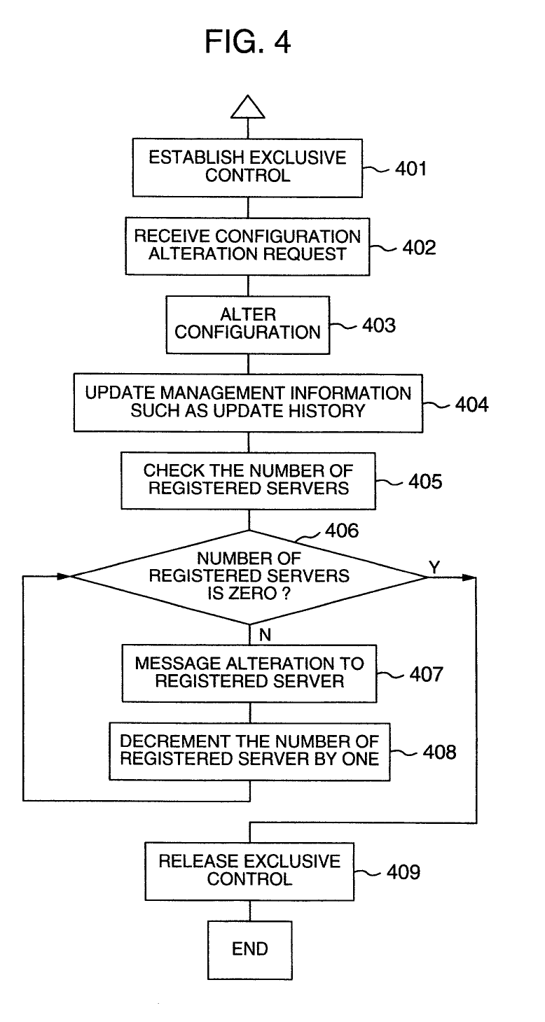

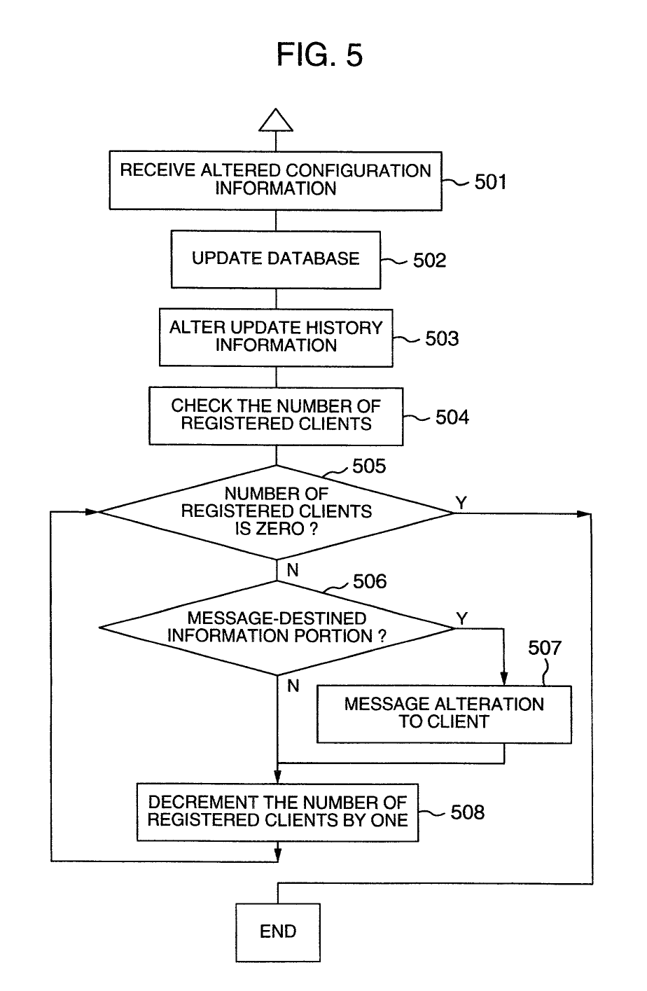

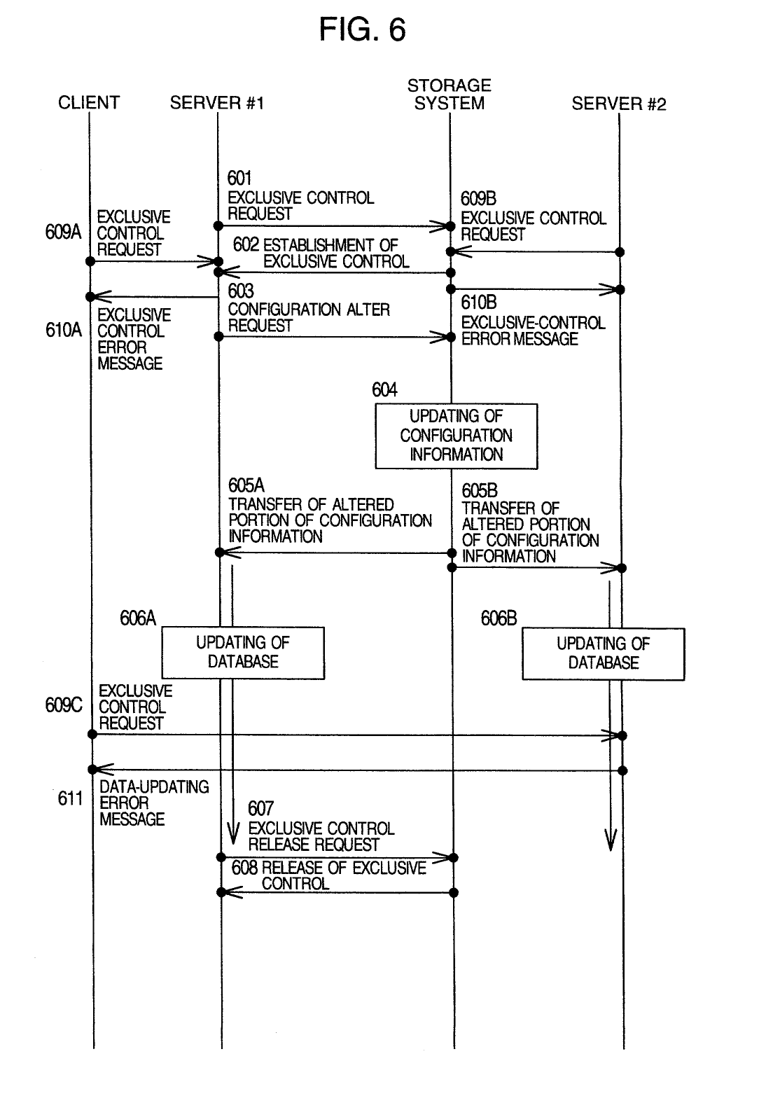

Further, FIG. 4 is a flow chart for illustrating, by way of example, operation of the storage system based on the storage managing scheme according to the instant embodiment of the invention, and FIG. 5 is a flow chart for illustrating, by way of example, operation of the storage managing server based on the storage managing scheme according to the instant embodiment of the invention. Furthermore, FIG. 6 is a view for illustrating flows of processings upon execution of a request for alteration of the configuration information of the storage system as issued by the storage managing server according to the instant embodiment of the invention.

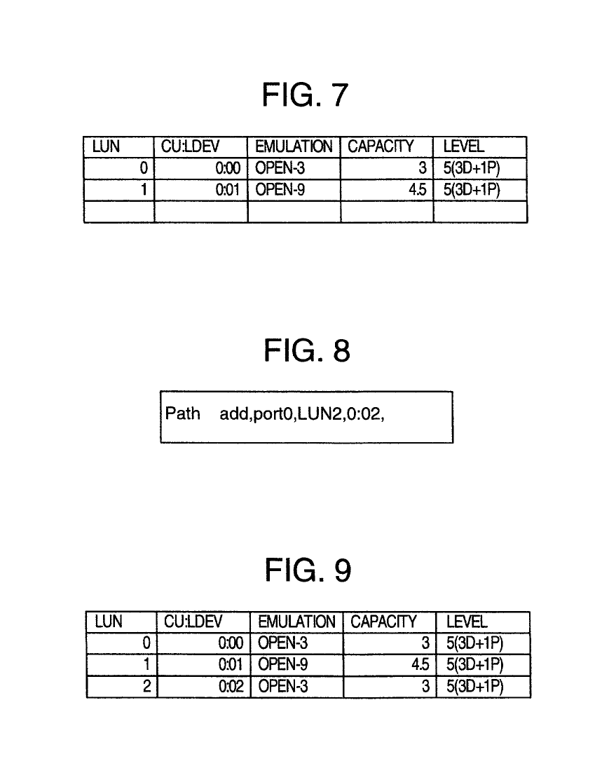

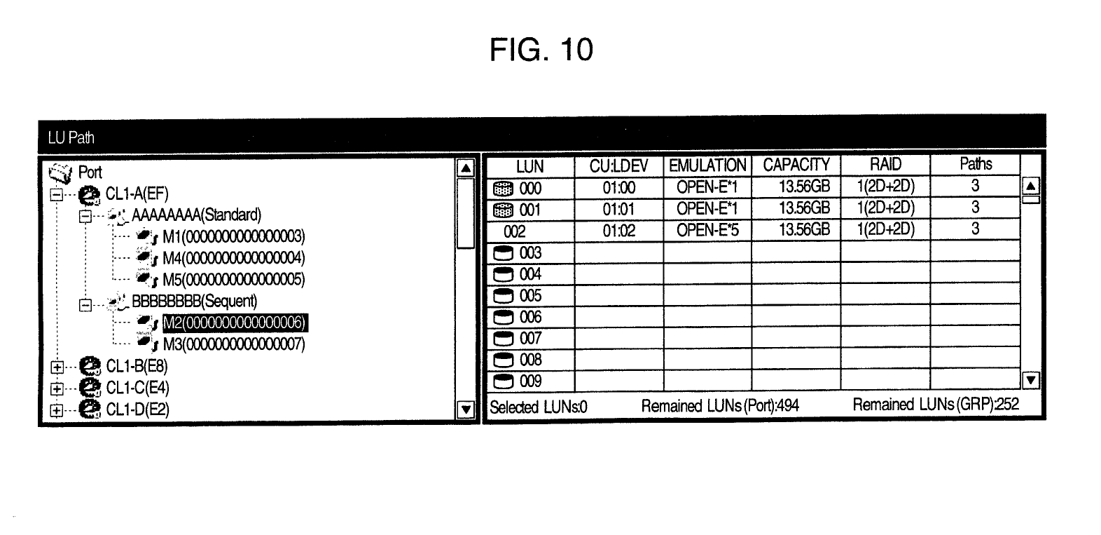

Additionally, FIG. 7 is a view illustrating a part of path information contained in the configuration information, FIG. 8 is a view showing, by way of example, a request for alteration of the configuration of the storage system, FIG. 9 is a view showing a part of the path information after the alteration of the configuration, and FIG. 10 is an image diagram showing an example of the configuration information displayed on a storage managing client.

In the network structure shown in FIG. 1, a storage system 106 is connected to a storage managing server 111 and storage managing clients 112 which are designed for management/control of the storage system 106. In addition, a main frame and a data transaction server are connected to the storage system 106 by way of relevant ports for the purpose of storing data in a storage 101 incorporated in the storage system 106, although they are omitted from illustration. The data can be stored in the storage 101 from the data transaction server, i.e., the storage system can be set to the state capable of operations, only by determining the configuration information of the storage system such as the attributes of the port, connection mode for the connection through an optical fiber and address therefor, path designation for LU (Logical Units) No., etc.

The storage system 106 shown in FIG. 1 incorporates a storage control mechanism such as, for example, a port (not shown) for controlling the transfer of the data to be stored between the storage 101 and the data transaction server or the like. The configuration information concerning the storage 101 and the connection status of the data transaction server or the main frame connected to the storage 101 is stored in the form of a group or set of configuration information 103 in a configuration information file 102. By modifying or rewriting the configuration information in response to the command issued from the storage managing server 111 or the storage managing client 112, it is possible to modify or alter the system configuration setup of the storage 101 and the data transaction server or the main frame or the like.

Basically, for altering or modifying the configuration information of the storage system 106 the storage managing server 111 executes the relevant command. It should however be added that the command for alteration of the configuration information can also be executed by the storage managing client 112 disposed at a remote site for given one of the configuration information through the medium of the storage managing server 111.

In the case of the instant embodiment of the invention now under consideration, all the configuration information for the storage system 106 is stored in the storage managing server 111 in the form of a database 107 in which configuration information 108 and configuration information update flags (FLG) (update history information of the configuration information, e.g. numerals or numbers indicative of the sequential order of the update events or history) 109 serving as the management information are stored. More specifically, the configuration information 108 is stored in the database in the form which can easily be recognized or understood by the storage managing server 111 and the storage managing client 112. The storage managing client 112 incorporates therein a so-called manager (functional name of software for disposing of the request for alteration of the configuration) which validates the request for alteration of the configuration of the storage system through the medium of the storage managing server 111.

The configuration information 103 stored in the storage system 106 and the configuration information 108 stored in the storage managing server 111 are utterly identical with each other in respect to the contents of the information, wherein the signal format for the configuration information 108 is so selected as to be easy to understand by describing the information 108, for example, in the form of text.

Exemplary descriptions of the configuration information and the update history information will be elucidated below in more concrete by reference to FIG. 1. The information concerning the port attributes may be written in a top frame of the configuration information array 103, while the path designation may be written in a succeeding frame with the relevant update FLGs (flags) (update history information) being written in numerals corresponding to the individual configuration information, respectively. The storage managing clients 112 are not necessarily required in the system according to the instant embodiment of the invention. These storage managing clients 112 can be disposed at remote sites to serve for management/control of the configuration information 103 by fetching all or given one(s) from a plurality of configuration information designated generally by numeral 103. To this end, the storage managing clients 112 may be connected to the storage managing server 111 for making access to the storage system 106 through the medium of the storage managing server 111. Thus, in view of the convenience of the remote management facility, it is preferred to provide a plurality of storage managing clients 112 in the system according to the present invention.

In the storage system according to the instant embodiment of the invention, the storage management control means 105 is so designed as to receive the request for alteration of setup of the storage system configuration as issued by the storage managing server 111, to thereby perform alteration of the configuration on the basis of the configuration alteration request issued to the storage system. In that case, the configuration information 103 which is contained in the configuration information file 102 and which corresponds to the configuration alteration request is updated, being accompanied with updating of the configuration information update history information (management information) 104 as well. Upon completion of the configuration alteration, the storage management control means 105 generates data to be transferred by collecting all the updated configuration information 103 and the corresponding update history information (management information) 104, which data is then transferred to the storage managing server 111 connected to the storage system 106.

Upon reception of the data in the storage managing server 111, the database 107 of the configuration information is automatically updated. More specifically, the altered configuration information of the storage system 106 is received by the storage managing means 110 incorporated in the storage managing server 111, whereon only the updated configuration information is generated on the basis of the data received with the update history information relevant to the updated configuration information being altered correspondingly by the storage managing means 111. By changing or replacing only the updated or altered portion of the configuration information and the corresponding update history information (management information) 109 contained in the database 107 of the storage managing server 111 in this way, the database 107 can be renewed to the up-to-date information status.

In other words, when the flow of the information to/from the storage managing server 111 concerned is considered, the request for the configuration alteration of the storage system as issued from, for example, an auxiliary storage managing server or another storage managing server or the storage managing client or the above-mentioned concerned storage managing server is effective for altering or modifying the configuration information 103 and the update history information (management information) 104 stored in the storage system 106 in respect to only the portions of these information to which the alteration request is directed. Subsequently, only the altered portions of the configuration information 103 and the corresponding update history information 104 stored in the configuration information file 102 are transferred to the concerned storage managing server 111, whereby the configuration information 108 and the update history information 109 contained in the database 107 of that server 111 are altered to the up-to-date status only in the portion corresponding to the altered portion of the configuration information file 102 and the update history information 104 as transferred. At this juncture, it should be mentioned that the data to be transferred from the storage managing server 111 to the storage client 112 upon alteration of the configuration information may be composed only of the update history information (management information) 104, as will be described hereinafter, because the configuration information 103 paired with the update history information (management information) 104 may be transferred later on when the network system is not busy.

Upon completion of the update processing, the storage managing means 110 of the storage managing server 111 sends the update history information as altered (updated management information in more general terms) to the storage managing clients 112. In this conjunction, it should be noted that in the case of the update processing of the database which has manually been performed heretofore, the waiting time of the user (the user of the storage managing client) will necessarily include the additional time taken for rearranging the database. By contrast, according to the teachings of the invention, updating of the database is carried out without being aware of by the user by availing of the opportunity of updating the configuration information.

At this juncture, referring to FIG. 6, a flow of processings for altering the configuration information in practical application will be described in concrete by taking as example the configuration information (path information) shown in FIG. 7.

For altering the configuration of the storage system, starting from the storage managing server #1, a request for exclusive control is firstly issued to the storage system (step 601). In response, it is confirmed in the storage system that the exclusive control has not been established with any other storage server (e.g. server #2 shown in FIG. 6), whereon establishment of the exclusive control with the server #2 is messaged to the storage managing server #1 (step 602). From this time point, the state in which the exclusive control has been established is sustained until the exclusive control is released. Parenthetically, when a request for the exclusive control is issued from a storage managing client or other server in this state (steps 609A, 609B), an error message to the effect that the exclusive control has already been established (exclusive-control error message) is sent to the storage managing client or other server attempting to establish the exclusive control (steps 610A, 610B).

Upon establishment of the exclusive control, the configuration alteration request is issued from the storage managing server #1 (step 603). The configuration alteration request can be effectuated, by way of example, by generating the request in a predetermined format such as typified by a path add request format illustrated in FIG. 8 on the basis of bus information of a port “0” illustrated in FIG. 7 and sending the request to the storage system. In the storage system, the configuration information is updated in accordance with the configuration alteration request as received (step 604). More specifically, upon reception of, for example, the path add request illustrated in FIG. 8, relevant information is added, being derived from the request. By way of example, in the case of addition of the path information mentioned above, it is checked on the basis of “CU:LDEV” information (information of Emulation, Level, Size, etc.) whether or not the configuration alteration can be realized without involving any problem. When it is decided that no problem will be encountered, alteration or modification of the information configuration is carried out.

Upon completion of alteration of the configuration information, only the altered portion thereof is sent to the servers #1 and #2 (steps 605A, 605B). Upon reception of the information concerning the altered portion, the storage managing servers #1 and #2 update the respective databases on the basis of the received information (steps 606A, 606B). Thus, the databases of the servers #1 and #2 are updated to the state added with the path information, as illustrated exemplarily in FIG. 9. In succession, upon completion of the updating, an exclusive control release request is issued (step 607), whereby the storage system is released from the exclusive control (step 608).

By the way, when a storage managing client issues an exclusive control request to the storage managing server #2 for which the exclusive control is not validated in the course of updating the database of the server #2 (step 609C), an error messaging that the data updating is being carried out (data-updating error message) is sent back to the storage managing client from the storage managing server #2. In the case where the configuration alteration is to be carried out, starting from the storage managing client, the exclusive control is firstly validated between that storage managing client and the storage managing server, whereon the exclusive control with the storage system is put into effect. This exclusive control request can be effectuated by selecting the connection-destined storage system on a GUI. The succeeding processing flow is similar to that described above.

In the case where alteration of the configuration is to be performed from the storage managing client by adding information contained in displayed data such as illustrated in FIG. 10 (e.g. by adding the path information as mentioned previously), a port to be added is selected from “PORT” information displayed at the lefthand side as viewed in FIG. 10. Then, the window shown at the righthand side in FIG. 10 is opened. By clicking the row in which no numerals are entered in this state, the information to be added can be inputted, whereby a configuration alteration request command can be issued to the storage managing server.

Again, referring to FIGS. 2 and 4, the storage managing scheme according to an embodiment of the present invention will be described in detail in conjunction with the information transfer or data transaction between the storage system 213 and the storage managing server on the presumption, only by way of example, that configuration information B 202 is to be updated. For enabling the configuration alteration of the storage system 213 from the storage managing server, the exclusive control is firstly established between the storage system 213 and the storage managing server to thereby inhibit reception of the request for alteration of the configuration issued from any other server(s) connected (step 401).

Upon establishment of the exclusive control, the configuration alteration request issued from the storage managing server is received by the storage management control means (105 in FIG. 1) incorporated in the storage system 213 (step 402), whereupon alteration of the configuration information is executed for the configuration information B 202 to be altered (step 403). Additionally, the numerical value “8” of the update history information (management information) 205 which is paired with the altered configuration information B 202 is incremented to “9” (step 404). At this juncture, it should be mentioned that in the case of the example illustrated in FIG. 2, the update history information as updated is represented by the numeral “9” indicative of the sequential order in which the configuration information has been altered. Parenthetically, in the case where a plurality of configurations are simultaneously altered en bloc, one and the same numeral may be assigned to the plurality of altered configuration information mentioned above as the update history information therefor.

Upon completion of updating of all the configuration information for which the update request has been accepted, the number of the registered servers is determined by referencing a registered server list 209 stored in the storage system 213 (step 405), whereon the altered configuration information B 202 and the corresponding update history information (management information) B 205 as updated are transferred orderly to the storage managing servers registered in the registered server list (step 407) until the number of the registered servers becomes zero “0” (step 406). More specifically, the altered configuration information and the corresponding update history information (management information) as updated are firstly transferred to the server #1 (210). At the end of this transfer, the number of the registered servers is decremented by “1” (step 408). In succession, the altered configuration information and the corresponding update history information (management information) as updated are transferred to the server #2 (211) and thence to the server #3 (212) in this sequence until the number of the registered servers becomes zero “0”, whereon the processing exits the loop with the exclusive control being released (step 409). The processing then comes to an end.

In the case of the example illustrated in FIG. 2, it is assumed that the servers #1, #2 and #3 are employed as the servers for managing the storage system 213, as can be seen in the registered server list 209. However, such arrangement may alternatively be adopted in which the server #1 is ordinarily used for managing the storage system 213 with the server #2 being used as the or auxiliary or secondary server so that the server #2 can be used in place of the server #1 when some fault takes place in the server #1, to thereby constantly maintain the whole system in the operating state.

As is apparent from the above, even the database incorporated in the storage managing server to which the configuration information alteration request is not issued is also updated by availing of the opportunity of updating the configuration information without need for making the user be aware of it. In other words, the user can access the storage system without being forced to wait for, to a great advantage.

Next, referring to FIGS. 3 and 5, the storage managing scheme according to an embodiment of the invention will be described in detail in conjunction with the transfer or transaction of information between the storage managing server and the storage managing client on the presumption, only by way of example, that configuration information B 304 is to be updated. At first, when the storage managing server #3 (302) receives the configuration alteration information from the storage system, the updated configuration information B 304 and the corresponding update history information B 305 are stored in a temporary storing area 303 (step 501). Subsequently, the configuration information B 307 of the database 312 prepared in the storage managing server #3 is updated on the basis of the transferred configuration information (step 502). In succession, the numerical value of the update history information B 310 accompanying the configuration information is updated to “9” from “8” on the basis of the transferred update history information (step 503).

Upon completion of updating of all the transferred configuration information, the number of the registered storage managing clients is determined by referencing a connected storage managing client list (step 504). The control procedure described below is repeated until the number of the registered storage managing clients becomes zero “0” (step 505).

More specifically, it is checked in a step 506 whether or not coincidence is found between storage-managing-client-destined message information 313 stored in the storage managing server #3 and the portion of alteration of the configuration information. When the decision step 506 results in affirmation “Y”, the update history information G of the configuration information is sent to the storage managing client in a step 507. Subsequently, the number of the storage managing clients is decremented by one (step 508). The procedure mentioned above is repetitively executed until the number of the storage managing clients becomes zero. In this way, when the request for configuration alteration is issued from the storage managing client, it is already known which of the configuration information has been altered, which means that only the altered configuration information may be updated. Thus, the processing time involved in the use of the system by the user can be shortened, to an advantage.

Further, in a step 507 shown in FIG. 5, not only the update history information but also the altered configuration information is transferred from the storage managing server to thereby allow the configuration information to be updated in the storage managing client as well. Thus, owing to the arrangement that the altered configuration information is transferred to the storage managing client, the processing time for making available the configuration information for the user can significantly be shortened.

As can now be understood from the foregoing description, in the system according to the illustrated embodiment of the present invention, the update history information (management information) is stored in the storage system for each of the individual configuration information, respectively, wherein the system is provided with the means or facility for updating the update history information concerning the alteration of the portion(s) or pieces of the configuration information stored in the storage in combination with the means or facility for automatically transferring the altered or modified configuration information and the updated management information (i.e., the update history information) to the storage managing server(s) connected to the storage system upon every updating of the management information (update history information).

Further, the storage managing server stores therein the storage configuration information in the form of a database together with the update history information (management information) for each of the individual configuration information, respectively. Thus, when the update history information is updated, not only the configuration information stored in the storage managing server is updated but also the updating of the configuration information is informed to the storage managing client(s) on the basis of the storage managing client name(s) registered in the storage managing server and the portion(s) or piece(s) of the configuration information to be informed on a storage-managing-client basis.

By virtue of these features, the amount or quantity of the information transferred by way of the network can be suppressed to a minimum, while reducing to a minimum the number of processing steps involved in generating or rearranging the database(s) in the storage managing server(s) and the storage managing client(s). Besides, by automatically transferring the altered configuration information from the storage system to the storage managing server, the latter can always be maintained in the up-to-date state, which means that there arises no necessity of updating the database upon alteration of the configuration information and thus the speed of processing can correspondingly be increased.

In the foregoing description, it has been presumed that the storage system is managed by the storage managing server. However, the present invention is never restricted to employment of such storage managing server. In other words, so far as the database storing therein the storage configuration information and the update history information thereof is available, any appropriate external control means may be employed. Of course, it is contemplated that the phrase “external control means” represents a higher rank concept encompassing conceptually the storage managing server.

According to the teachings of the invention, transaction of data or information can be performed while suppressing to a minimum the load imposed on the network.

With the conventional storage managing server, the database has heretofore been updated manually. Consequently, the time taken for rearranging the database is added to the waiting time. By contrast, according to the teachings of the present invention disclosed herein, updating of the database is performed by availing of the opportunity of altering or modifying the configuration information without coming under the user's notice. In other words, the waiting time is not involved for the user due to the alteration of the database, to advantageous effect.

It should be further understood by those skilled in the art that the foregoing description has been made on embodiments of the invention and that various changes and modifications may be made in the invention without departing from the spirit of the invention and the scope of the appended claims.

What is claimed is:

1. In a storage system comprising a storage in which data are stored, a configuration file for storing configuration information required for operating said storage system, inclusive of path setting information for said storage, and additionally storing update history information indicative of information having been updated for each of said configuration information, and storage management control means for altering said configuration information and said update history information in response to an external request,
a method of managing said storage with the aid of a storage managing server which comprises a database storing therein configuration information and update history information for each of said configuration information for managing said storage system, and storage managing means for issuing a request for altering the configuration information to said storage system while reflecting result of the alteration of said configuration information in said database,
said storage management method comprising:
a first step of responding to issuance of a request for alteration of said configuration information by said storage managing server to said storage system for thereby updating relevant one of the configuration information stored in said configuration information file and the update history information paired with said relevant configuration information; and
a second step of transferring only the altered configuration information and update history information to said storage managing server from said storage system to thereby allow the corresponding configuration information and update history information both stored in said database to be updated.

2. In a storage system comprising a plurality of storages in which data are stored, a configuration information file for storing a plurality of storage configuration information inclusive of path setting information for said plurality of storages and update history information prepared in correspondence to said plurality of storage configuration information, respectively, for indicating that corresponding configuration information has been updated, and storage management control means responsive to a request for alteration of storage configuration as issued from external control means to thereby alter said storage configuration while altering said storage configuration information and said update history information in correspondence to alteration of said storage configuration, said external control means including a database storing therein said configuration information and said update history information,
a method of managing said storages, comprising:
a first step in which said storage management control means responds to a request issued by said external control means for thereby altering configuration of said storage while updating said configuration information and update history information stored in said configuration information file in correspondence to the alteration of said storage configuration;
a second step in which the configuration information and the update history information which have been updated in said first step are transferred to said external control means; and
a third step in which said external control means updates said database on the basis of said information transferred to said external control means.

3. In a storage system comprising a storage in which data are stored, a configuration file for storing therein configuration information required for operating said storage system, inclusive of path setting information for said storage, and update history information indicative of information having been updated for each of said configuration information, and storage management control means for altering said configuration information and said update history information in response to an external request,
said storage system being equipped with a storage managing server which comprises a database storing therein configuration information and update history information for each of said configuration information for managing said storage system, and storage managing means for issuing a request for altering the configuration information to said storage system while reflecting result of the alteration of said configuration information in said database, and further equipped with at least one storage managing client connected to said storage managing server by way of a network and designed to request alteration of the configuration information of said storage system,
a method of managing said storage comprising:
a first step of responding to issuance of a request for alteration of said configuration information of said storage system from said storage managing client for thereby updating relevant configuration information stored in said configuration information file and the update history information paired with said relevant configuration information through the medium of said storage managing means of said storage managing server; and
a second step of transferring the altered configuration information and update history information to said storage managing client from said storage system through the medium of said database and said storage managing means of said storage managing server to thereby update the corresponding configuration information and update history information stored in said storage managing client.

4. A storage management method according to claim 3, further comprising:
a third step of responding to alteration of the configuration information of said storage system to thereby register in said storage managing server the configuration information which is to be informed to said storage managing clients on a client-by-client basis; and
a fourth step of responding to alteration of said registered configuration information to thereby transfer the altered configuration information and the update history information paired with said altered configuration information to said storage managing client.

5. A storage management method according to claim 3,
wherein upon alteration of said registered configuration information, only said update history information paired with said altered configuration information is transferred to said storage managing client instead of transferring both of said altered configuration information and said update history information paired with said altered configuration information.

6. A storage management method according to claim 1,
said storage managing server being comprised of a primary storage managing server and a secondary storage managing server, both of said storage managing servers being held in said storage system in the form of a registered server list,
said storage management method further comprising:
a third step of responding to issuance of a request for alteration of said configuration information from any one of said storage managing servers to said storage system to thereby transfer only the altered configuration information and update history information to said storage managing servers, respectively, from said storage system.

7. A storage management system for a storage system which comprises a storage for storing data, a configuration information file for storing configuration information required for operating said storage system, inclusive of path setting information for said storage, and update history information indicative of information having been updated for each of said configuration information, and storage management control means for altering said configuration information and said update history information in response to an external request,
said storage management system comprising a storage managing server which includes a database storing therein configuration information and update history information for each of said configuration information for managing said storage system,
said storage management system further comprising:
storage managing means for issuing a request for altering the configuration information to said storage system while reflecting result of the alteration of said configuration information in said database,
wherein in response to issuance of a request for alteration of said configuration information from said storage managing server to said storage system, relevant one of the configuration information stored in said configuration information file and the update history information paired with said relevant configuration information are updated;
wherein said storage system transfers said updated configuration information and update history information to said storage managing server; and
wherein said storage managing server updates the corresponding configuration information and update history information both stored in said database.

8. A system for managing a storage system which comprises a plurality of storages in which data are stored, a configuration information file for storing a plurality of storage configuration information, inclusive of path setting information for said plurality of storages, and update history information provided in correspondence to said plurality of storage configuration information, respectively, for indicating that corresponding configuration information has been updated, and storage management control means responsive to a request for alteration of storage configuration as issued from external control means to thereby alter said storage configuration while altering said storage configuration information and said update history information in correspondence to alteration of said storage configuration,
wherein said external control means includes a database storing said configuration information and said update history information;
wherein said storage management control means responds to a request issued by said external control means for thereby altering said storage configuration and updating said configuration information and said update history information in correspondence to the alteration of said storage configuration;
wherein said configuration information and said update history information which have been updated are transferred to said external control means; and
wherein said external control means updates said database on the basis of said information transferred to said external control means.
